(19) United States
(12) Patent Application Publication
(10) Pub. No.: US 2020/0070413 A1
(43) Pub. Date: Mar. 5, 2020

(54) THREE-DIMENSIONAL OBJECT DATA GENERATION APPARATUS, THREE-DIMENSIONAL OBJECT FORMING APPARATUS, AND NON-TRANSITORY COMPUTER READABLE MEDIUM

(71) Applicant: FUJI XEROX CO., LTD., Tokyo (JP)

(72) Inventor: Naoki HIJI, Kanagawa (JP)

(73) Assignee: FUJI XEROX CO., LTD., Tokyo (JP)

(21) Appl. No.: 16/274,250

(22) Filed: Feb. 13, 2019

(30) Foreign Application Priority Data
Aug. 28, 2018 (JP) 2018-159176

(51) Int. Cl. B29C 64/188; B29C 64/386; B29C 64/153

(52) U.S. Cl. CPC B29C 64/188; B29C 64/153; B29C 64/386

(57) ABSTRACT

A three-dimensional object data generation apparatus includes a feature value setting unit that sets a feature value for each of plural voxels indicating, in three-dimensional object data, a three-dimensional object, an obtaining unit that obtains correspondence between a forming condition of a three-dimensional object forming apparatus that forms the three-dimensional object and the feature value, and a forming condition setting unit that sets the forming condition corresponding to the feature value for each of the plural voxels using the correspondence.

### CROSS-REFERENCE TO RELATED APPLICATIONS

This application is based on and claims priority under 35 USC 119 from Japanese Patent Application No. 2018-159176 filed Aug. 28, 2018.

### BACKGROUND

### (i) Technical Field

The present disclosure relates to a three-dimensional object data generation apparatus, a three-dimensional object forming apparatus, and a non-transitory computer readable medium.

### (ii) Related Art

Japanese Unexamined Patent Application Publication No. 2017-109427 discloses a solid body forming apparatus including a dot forming unit that forms dots included in a solid body to be formed and a support member that supports the solid body and a control unit that controls the forming of the solid body and the support member including the dots. The control unit arranges the dots in a voxel group that represents the support member on the basis of an input value indicating a forming ratio of the dots in voxels included in the voxel group and a dither mask such that a support structure that supports the solid body is formed.

Japanese Unexamined Patent Application Publication No. 2017-30177 discloses a solid body forming apparatus that includes a head unit capable of discharging liquid, a curing unit that forms dots by curing the liquid discharged from the head unit, and a forming control unit that controls operation of the head unit such that a solid body is formed as a group of dots by representing a shape of the solid body to be formed with a voxel group and forming the dots in voxels, in the voxel group, determined by a determination unit as voxels in which the dots are to be formed. The determination unit determines the voxels in which the dots are to be formed in accordance with a forming index, which is a value according to a forming ratio of the dots in voxels in the voxel group inside the solid body and a result of comparison with a threshold included in the dither mask.

Japanese Unexamined Patent Application Publication No. 2018-1725 discloses a three-dimensional data generation apparatus including a measurement result reception unit that receives a result of measurement of a shape of a first object output from an output apparatus using first three-dimensional data specifying the shape of the first object, a correction data calculation unit that calculates correction data on the basis of an error from the shape specified by the first three-dimensional data corresponding to the result of measurement received by the measurement result reception unit, and a data correction unit that corrects second three-dimensional data specifying a shape of a second object using the correction data calculated by the correction data calculation unit.

### SUMMARY

When a three-dimensional object is formed, a user might desire to use different feature values (e.g., hardness, density, etc.) for different parts of the three-dimensional object. When different degrees of hardness are used for different parts of a three-dimensional object in the examples of the related art, for example, correspondence between hardness and shape is obtained in advance by actually measuring the hardness of various shapes and specifying a shape of each part on the basis of the obtained correspondence.

It is troublesome, however, to specify a shape for each part.

Aspects of non-limiting embodiments of the present disclosure relate to a three-dimensional object data generation apparatus, a three-dimensional object forming apparatus, and a non-transitory computer readable medium capable of adjusting feature values without specifying a shape for each part of a three-dimensional object.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a three-dimensional object data generation apparatus including a feature value setting unit that sets a feature value for each of a plurality of voxels indicating, in three-dimensional object data, a three-dimensional object, an obtaining unit that obtains correspondence between a forming condition of a three-dimensional object forming apparatus that forms the three-dimensional object and the feature value, and a forming condition setting unit that sets the forming condition corresponding to the feature value for each of the plurality of voxels using the correspondence.

### BRIEF DESCRIPTION OF THE DRAWINGS

An exemplary embodiment of the present disclosure will be described in detail based on the following figures, wherein:

FIG. 1 is a diagram illustrating the configuration of a three-dimensional object forming system;

FIG. 2 is a diagram illustrating the configuration of a three-dimensional object data generation apparatus;

FIG. 3 is a diagram illustrating an example of a three-dimensional object represented by voxel data;

FIG. 4 is a diagram illustrating the configuration of a three-dimensional object forming apparatus;

FIG. 5 is a flowchart illustrating a process achieved by a program for generating three-dimensional object data;

FIG. 6 is a diagram illustrating an example of hardness set for voxels;

FIG. 7 is a graph indicating correspondence between hardness and forming speed;

FIG. 8 is a diagram illustrating object material route data;

FIG. 9 is a diagram illustrating routes set in accordance with a shape obtained by smoothing a surface of a three-dimensional object;

FIG. 10 is a diagram illustrating a route continuously set along a circumference of the smoothed three-dimensional object;

FIG. 11 is a diagram illustrating degrees of connection with adjacent voxels; and

FIG. 12 is a diagram illustrating routes set for voxels on the basis of the degrees of connection with adjacent voxels.

### DETAILED DESCRIPTION

An exemplary embodiment of the present disclosure will be described hereinafter with reference to the drawings.

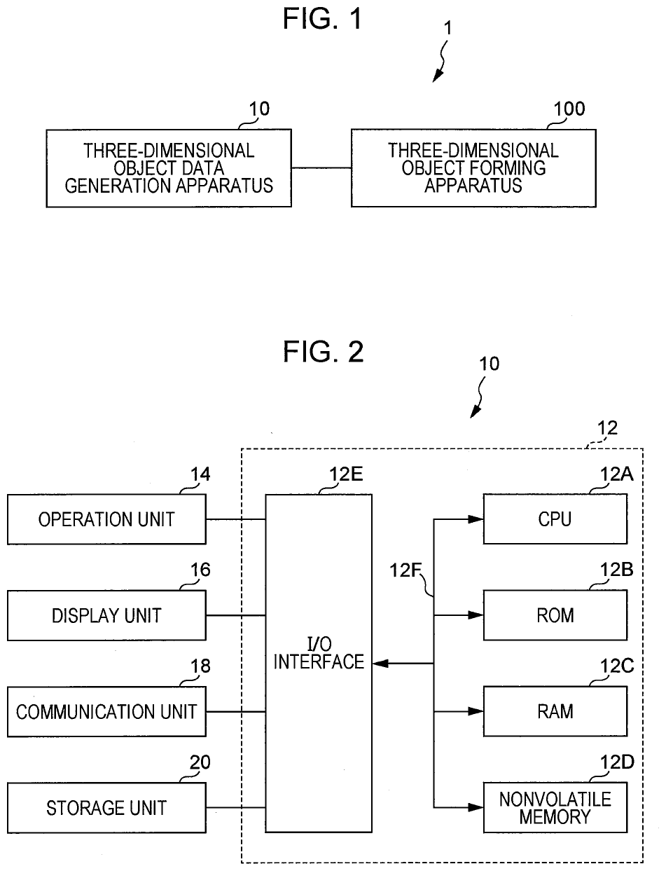

FIG. 1 is a diagram illustrating the configuration of a three-dimensional object forming system 1 according to the present exemplary embodiment. As illustrated in FIG. 1, the three-dimensional object forming system 1 includes a three-dimensional object data generation apparatus 10 and a three-dimensional object forming apparatus 100.

Next, the configuration of the three-dimensional object data generation apparatus 10 according to the present exemplary embodiment will be described with reference to FIG. 2.

The three-dimensional object data generation apparatus 10 is a personal computer, for example, and includes a controller 12. The controller 12 includes a central processing unit (CPU) 12A, a read-only memory (ROM) 12B, a random-access memory (RAM) 12C, a nonvolatile memory 12D, and an input/output (I/O) interface 12E. The CPU 12A, the ROM 12B, the RAM 12C, the nonvolatile memory 12D, and the I/O interface 12E are connected to one another through a bus 12F.

An operation unit 14, a display unit 16, a communication unit 18, and a storage unit 20 are connected to the I/O interface 12E. The CPU 12A is an example of a feature value setting unit, an obtaining unit, a forming condition setting unit, and a smoothing unit.

The operation unit 14 includes, for example, a mouse and a keyboard.

The display unit 16 is, for example, a liquid crystal display.

The communication unit 18 is an interface for communicating data with external apparatuses such as the three-dimensional object forming apparatus 100.

The storage unit 20 is a nonvolatile storage device such as a hard disk and stores a program for generating three-dimensional object data, which will be described later, three-dimensional object data (voxel data), table data representing correspondence between forming conditions and feature values of the three-dimensional object forming apparatus 100, details of which will be described later, and the like. The CPU 12A reads the program for generating three-dimensional object data stored in the storage unit 20 and executes the program.

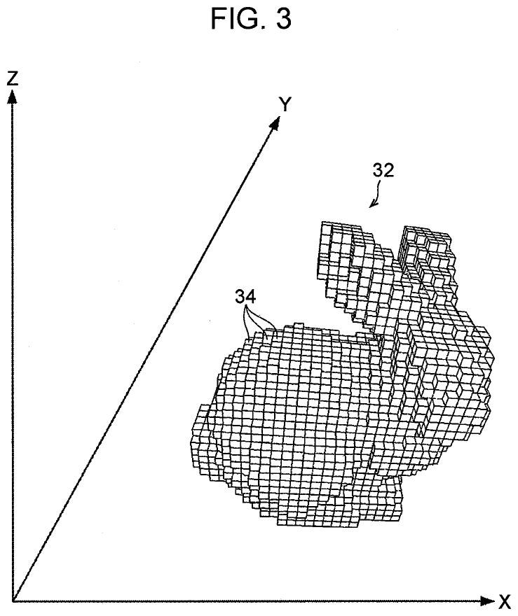

FIG. 3 illustrates a three-dimensional object 32 represented by three-dimensional object data (voxel data), which is a group of voxels. As illustrated in FIG. 3, the three-dimensional object 32 includes a plurality of voxels 34.

The voxels 34 are basic elements of the three-dimensional object 32. The voxels 34 may be rectangular parallelepipeds, for example, but may be spheres or cylinders, instead. A desired three-dimensional object is represented by stacking the voxels 34 on one another.

As a method for forming a three-dimensional object, for example, fused deposition modeling (FDM), in which a thermoplastic resin is plasticized and stacked to form a three-dimensional object, or selective laser sintering (SLS), in which a laser beam is radiated onto a powdery metal material to form a three-dimensional object through sintering, is used, but another method may be used, instead. In the present exemplary embodiment, a case where a three-dimensional object is formed using FDM will be described.

Next, a three-dimensional object forming apparatus that forms a three-dimensional object using three-dimensional object data generated by the three-dimensional object data generation apparatus 10 will be described.

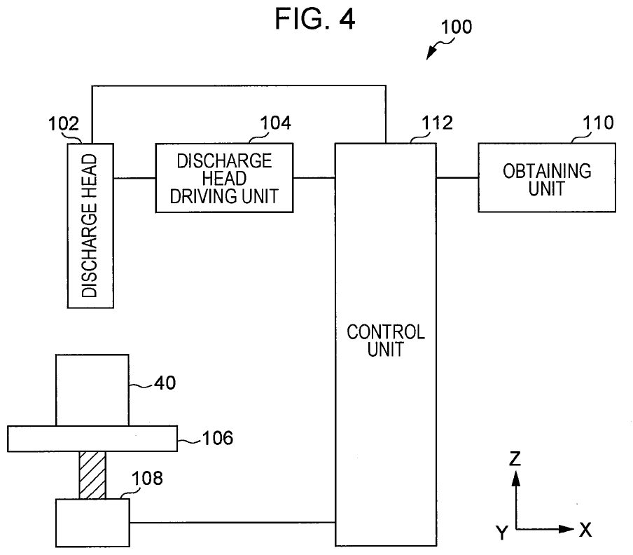

FIG. 4 illustrates the configuration of the three-dimensional object forming apparatus 100 according to the present exemplary embodiment. The three-dimensional object forming apparatus 100 forms a three-dimensional object using FDM.

As illustrated in FIG. 4, the three-dimensional object forming apparatus 100 includes a discharge head 102, a discharge head driving unit 104, a stand 106, a stand driving unit 108, an obtaining unit 110, and a control unit 112. The discharge head 102, the discharge head driving unit 104, the stand 106, and the stand driving unit 108 are an example of a forming unit.

The discharge head 102 includes an object material discharge head that discharges an object material for forming a three-dimensional object 40 and a support material discharge head that discharges a support material. The support material is used to support overhangs (also referred to as “projections”) of the three-dimensional object 40 and removed after the three-dimensional object 40 is formed.

The discharge head 102 is driven by the discharge head driving unit 104 and moves on an X-Y plane in two dimensions. The object material discharge head may include a plurality of discharge heads corresponding to object materials of a plurality of attributes (e.g., colors).

The stand 106 is driven by the stand driving unit 108 and moves along a Z axis.

The obtaining unit 110 obtains three-dimensional object data, object material route data, which indicates a discharge route of an object material, support material data, and support material route data, which indicates a discharge route of a support material, generated by the three-dimensional object data generation apparatus 10.

The control unit 112 drives the discharge head driving unit 104 to move the discharge head 102 in two dimensions and controls the discharge of the object material and the support material performed by the discharge head 102 such that the object material is discharged in accordance with the object material route data obtained by the obtaining unit 110 and the support material is discharged in accordance with the support material route data obtained by the obtaining unit 110.

Each time a layer has been formed, the control unit 112 drives the stand driving unit 108 to lower the stand 106 by a predetermined layer interval.

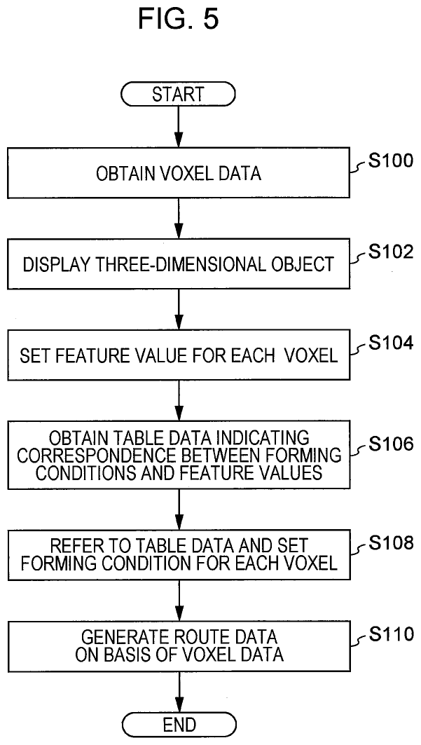

Next, the operation of the three-dimensional object data generation apparatus 10 according to the present exemplary embodiment will be described with reference to FIG. 5. A generation process illustrated in FIG. 5 is performed by causing the CPU 12A to execute a program for generating three-dimensional object data. The generation process illustrated in FIG. 5 is performed, for example, when a user has requested execution of the program. In the present exemplary embodiment, description of a process for generating support material data and support material route data is omitted.

In step S100, voxel data corresponding to a three-dimensional object to be formed is read, for example, from the storage unit 20. Alternatively, voxel data may be obtained from an external apparatus using the communication unit 18.

In step S102, three-dimensional object display data is generated from the voxel data obtained in step S100 and displayed on the display unit 16.

In step S104, a feature value is set for each pixel. For example, a user operates the operation unit 14 to select, in the three-dimensional object displayed on the display unit 16, voxels for which feature values are to be set and set desired feature values for the selected voxels.

A feature value may be a value relating to at least one of hardness, density, chromaticity, specific heat, electric resistance, and a degree of connection with adjacent voxels, for example, but is not limited to these.

The user may set a feature value for each pixel or may specify a range including a plurality of voxels and collectively set a single feature value in the specified range.

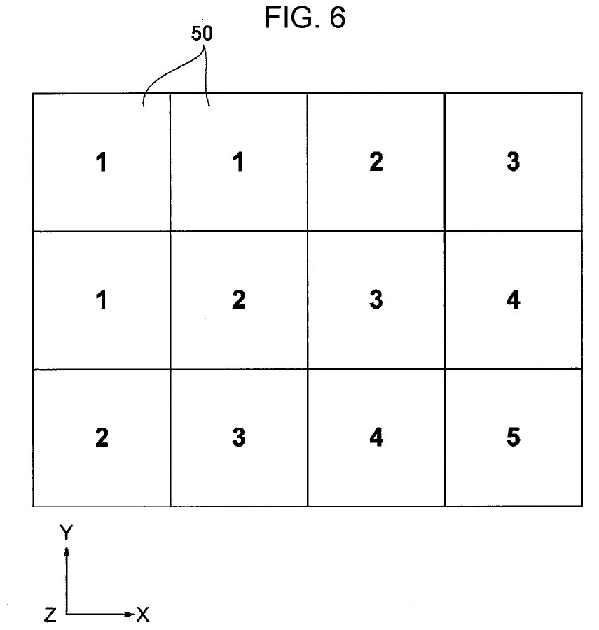

A case where hardness is set as a feature value will be described hereinafter. FIG. 6 illustrates a plurality of voxels 50 included in a part of a surface obtained by slicing a three-dimensional object along an X-Y plane.

Values in the voxels 50 indicate hardness set by the user. In the example illustrated in FIG. 6, values of 1 to 5 are set for the voxels 50 as hardness. The larger the value, the harder the voxel.

In step S106, the table data indicating correspondence between forming conditions and feature values of the three-dimensional object forming apparatus 100 is read from the storage unit 20.

A forming condition may be at least one of forming speed, at which the three-dimensional object forming apparatus 100 forms a three-dimensional object using FDM, feeding speed, at which an object material is fed, a distance between the discharge head 102 that discharges an object material and the stand 106 on which a three-dimensional object is formed, the temperature of the discharge head 102, and scanning intervals of an object material, for example, but is not limited to these.

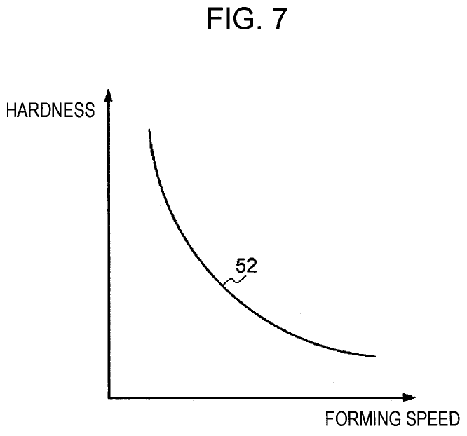

In the present exemplary embodiment, a case where a forming condition is forming speed and a feature value is hardness will be described. In this case, for example, the table data is table data indicating correspondence 52 between forming speed and hardness illustrated in FIG. 7. Alternatively, a numerical formula indicating correspondence between forming speed and hardness may be used instead of the table data.

The correspondence 52 is obtained from results of measurement of hardness at a time when three-dimensional objects have been actually formed at various forming speeds. The same holds for correspondence between other feature values and other forming conditions. Correspondence between various feature values and various forming conditions may be obtained in advance and stored in the storage unit 20.

As illustrated in FIG. 7, as forming speed increases, hardness decreases, and as forming speed decreases, hardness increases. As forming speed increases, the amount of the object material discharged per unit area decreases, and as forming speed decreases, the amount of the object material discharged per unit area increases. Therefore, when a linear object is formed, for example, as forming speed increases, the linear object becomes thinner and hardness decreases. As forming speed decreases, the linear object becomes thicker and hardness increases.

A forming condition when a three-dimensional object is formed using SLS is at least one of the intensity of laser light, the scanning speed of laser light, and a focal position of laser light, for example, but is not limited to these.

In step S108, the table data obtained in step S106 is referred to, and a forming condition is set for each voxel. That is, a forming condition corresponding to the feature value set in step S104 for each voxel is set while referring to the table data obtained in step S106. As a result, voxel data in which a forming condition is set for each voxel is generated.

In step S110, object material route data indicating a discharge route of the object material is generated on the basis of the voxel data generated in step S108, and support material route data indicating a discharge route of a support material is generated on the basis of support material data.

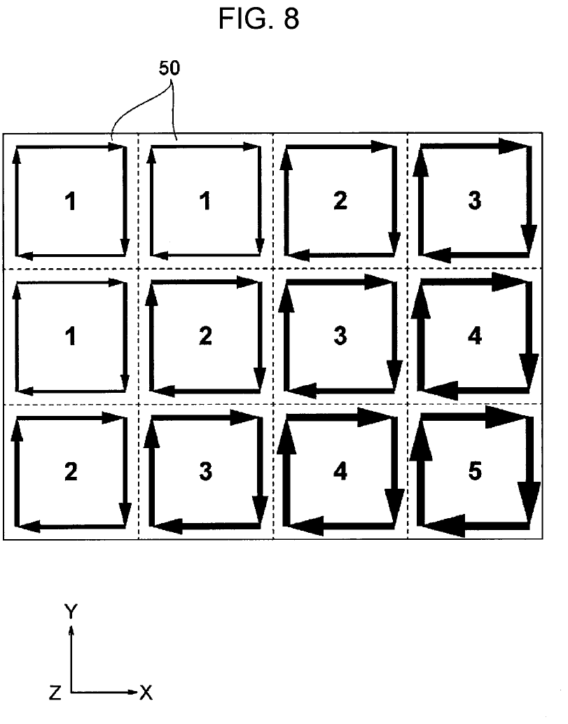

FIG. 8 illustrates an example of discharge routes of an object material using arrows. In the example illustrated in FIG. 8, a discharge route of an object material is indicated for each voxel 50 by arrows. The thickness of the arrows of each route indicates the thickness of lines formed by the discharged object material. That is, when forming speed is set low for a high level of hardness, a line formed by a discharged object material becomes thick.

In examples of the related art, three-dimensional object data needs to be generated by specifying a shape according to hardness for each part of a three-dimensional object, which is troublesome. In this case, hardness is adjusted for each part by, for example, making an object thicker for a higher level of hardness.

In the present exemplary embodiment, on the other hand, a forming condition is set in accordance with hardness without specifying a shape for each part of a three-dimensional object, and three-dimensional object data can be easily generated.

The obtaining unit 110 of the three-dimensional object forming apparatus 100 obtains the object material route data and the support material route data generated by the three-dimensional object data generation apparatus 10. The control unit 112 drives the discharge head driving unit 104 to move the discharge head 102 in two dimensions and controls the discharge of an object material and a support material such that the object material and the support material are discharged in accordance with the object material route data and the support material route data, respectively, obtained by the obtaining unit 110.

When controlling the discharge of the object material, the control unit 112 performs the control such that the object material is discharged under the forming condition set for each voxel indicated by the three-dimensional object data generated by the three-dimensional object data generation apparatus 10. That is, forming speed increases as hardness decreases, and forming speed decreases as hardness increases.

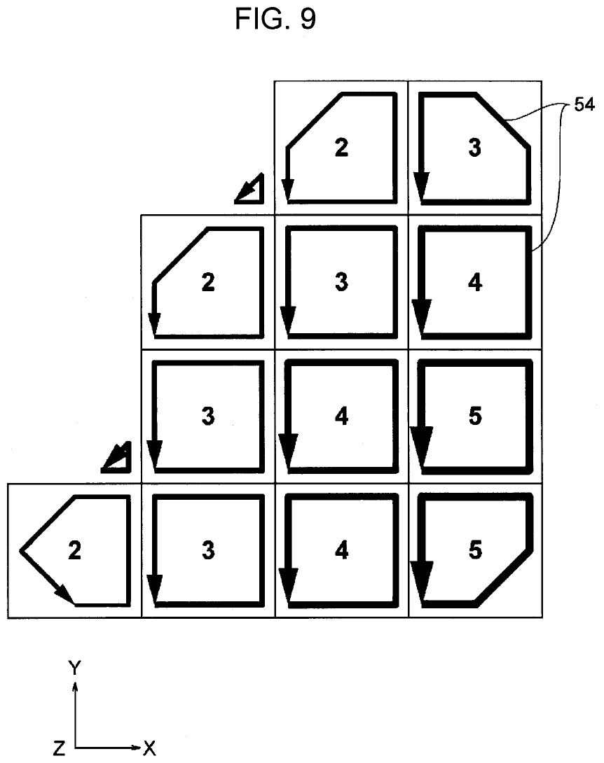

When the object material route data is generated in step S110, for example, a route may be set in accordance with a shape obtained by smoothing a surface of the three-dimensional object using a smoothing method such as marching cubes. FIG. 9 illustrates routes 54 set in accordance with a shape obtained by smoothing a surface of a three-dimensional object, that is, a circumference of a three-dimensional object, using marching cubes.

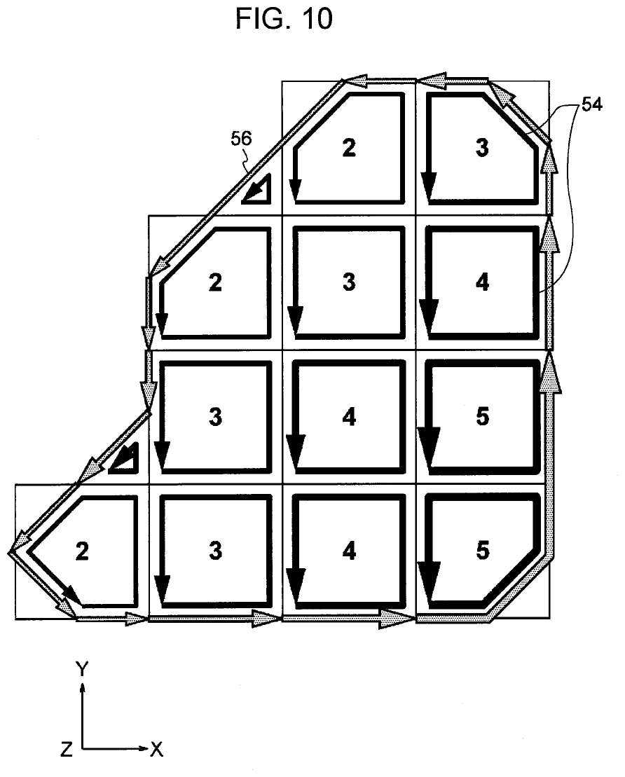

In addition, as illustrated in FIG. 10, a route 56 for continuously discharging an object material along the circumference of the smoothed three-dimensional object may be set.

If feature values include not only hardness but also a degree of connection with adjacent voxels, routes for forming a three-dimensional object may be set in accordance with the degree of connection with adjacent voxels.

In this case, in step S104, the degree of connection with adjacent voxels is set for every surface of each voxel in addition to hardness. When voxels are rectangular parallelepipeds, the voxels have six surfaces. The degree of connection with adjacent voxels, therefore, is set for each of the six surfaces.

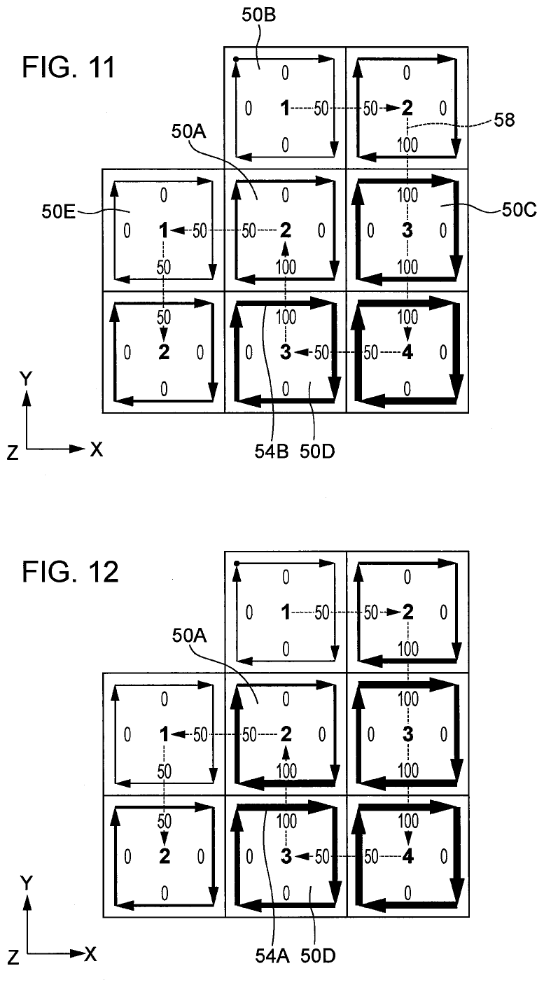

FIG. 11 illustrates an example of degrees of connection with adjacent voxels set for voxels. As for a voxel 50A, a degree of connection of 0 is set for surfaces in contact with voxels 50B and SOC, which are adjacent voxels. A degree of connection of 100 is set for a surface in contact with a voxel 50D, and a degree of connection of 50 is set for a surface in contact with a voxel 50E. The larger the value, the higher the degree of connection with an adjacent voxel.

In step S110, a route for voxels may be set using a degree of connection. More specifically, a route for voxels is set such that the route goes to surfaces having high degrees of connection. In the example illustrated in FIG. 11, for example, a route 58 for voxels indicated by a broken line is set.

A forming condition for a route of a surface for which a degree of connection is set may be adjusted in accordance with the degree of connection. For example, forming speed may be adjusted such that the hardness of a route of a surface for which a degree of connection is set increases as the degree of connection increases.

In an example illustrated in FIG. 12, a degree of connection of 100 is set for a surface of the voxel 50D in contact with the adjacent voxel 50A. A forming speed obtained by subtracting a predetermined correction value from a forming speed corresponding to a degree of hardness of 3, therefore, is set for a route 54A of the surface for which the degree of connection of 100 is set. The correction value increases as the degree of connection increases, and decreases as the degree of connection decreases. As a result, the forming speed for the route 54A illustrated in FIG. 12 becomes lower than a forming speed for a route 54B illustrated in FIG. 11, and hardness also becomes higher.

Although the present disclosure has been described on the basis of the exemplary embodiment, the present disclosure is not limited to the above exemplary embodiment. The exemplary embodiment may be modified or improved without deviating from the spirit of the present disclosure, and the technical scope of the present disclosure includes such modifications and improvements.

For example, although the three-dimensional object data generation apparatus 10 and the three-dimensional object forming apparatus 100 that forms a three-dimensional object on the basis of three-dimensional object data are separate components in the above exemplary embodiment, the three-dimensional object forming apparatus 100 may have the functions of the three-dimensional object data generation apparatus 10, instead.

That is, the obtaining unit 110 of the three-dimensional object forming apparatus 100 may obtain voxel data, and the control unit 112 may perform the generation process illustrated in FIG. 5 to generate three-dimensional object data.

If a resolution achieved by the three-dimensional object forming apparatus 100 during forming is lower than the resolution of voxels, that is, if intervals at which the three-dimensional object forming apparatus 100 discharges an object material are smaller than the size of voxels, for example, an average of feature values of a plurality of voxels may be calculated in step S108 illustrated in FIG. 5, and a forming condition corresponding to the calculated average may be set for the plurality of voxels.

In addition, the process for generating three-dimensional object data illustrated in FIG. 5 may be performed using hardware such as an application-specific integrated circuit (ASIC). In this case, the process can be performed at higher speed than when the process is performed using software.

Although the program for generating three-dimensional object data is installed on the storage unit 20 in the above exemplary embodiment, the program need not be installed on the storage unit 20. The program for generating three-dimensional object data according to the above exemplary embodiment may be provided using a non-transitory computer readable medium, instead. The program for generating three-dimensional object data in the present disclosure may be provided, for example, using an optical disc such as a compact disc read-only memory (CD-ROM) or a digital versatile disc read-only memory (DVD-ROM) or a semiconductor memory such as a universal serial bus (USB) memory or a memory card. Alternatively, the program for generating three-dimensional object data according to the above exemplary embodiment may be obtained from an external apparatus through a communication line connected to the communication unit 18.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A three-dimensional object data generation apparatus comprising:
a feature value setting unit that sets a feature value for each of a plurality of voxels indicating, in three-dimensional object data, a three-dimensional object;
an obtaining unit that obtains correspondence between a forming condition of a three-dimensional object forming apparatus that forms the three-dimensional object and the feature value; and
a forming condition setting unit that sets the forming condition corresponding to the feature value for each of the plurality of voxels using the correspondence.

2. The three-dimensional object data generation apparatus according to claim 1,
wherein the feature value setting unit sets, for each of the plurality of voxels as the feature value, a value relating to at least one of hardness, density, chromaticity, specific heat, electric resistance, and a degree of connection with adjacent voxels.

3. The three-dimensional object data generation apparatus according to claim 2,
wherein the feature value is the degree of connection with adjacent voxels, and
wherein the forming condition setting unit sets a route for forming the three-dimensional object in accordance with the degree of connection with adjacent voxels.

4. The three-dimensional object data generation apparatus according to claim 3,
wherein the forming condition setting unit adjusts, in accordance with the degree of connection, a forming condition of a route of a surface for which the degree of connection has been set.

5. The three-dimensional object data generation apparatus according to claim 1,
wherein the forming condition setting unit sets, for each of the plurality of voxels as the forming condition in accordance with the feature value, at least one of forming speed, at which the three-dimensional object forming apparatus forms the three-dimensional object using fused deposition modeling, feeding speed, at which an object material is fed, a distance between a discharge head that discharges the object material and a stand on which the three-dimensional object is formed, temperature of the discharge head, and scanning intervals of the object material.

6. The three-dimensional object data generation apparatus according to claim 1,
wherein the forming condition setting unit sets, for each of the plurality of voxels as the forming condition in accordance with the feature value, at least one of intensity of laser light, scanning speed of the laser light, and a focal position of the laser light at a time when the three-dimensional object is formed using selective laser sintering.

7. The three-dimensional object data generation apparatus according to claim 1, further comprising:
a smoothing unit that smoothes a surface of the three-dimensional object.

8. The three-dimensional object data generation apparatus according to claim 7,
wherein the forming condition setting unit sets a route for forming the three-dimensional object along a circumference of a shape obtained by smoothing the surface of the three-dimensional object using the smoothing unit.

9. A three-dimensional object forming apparatus comprising:
a forming unit that forms a three-dimensional object on a basis of three-dimensional object data generated by the three-dimensional object data generation apparatus according to claim 1.

10. A non-transitory computer readable medium storing a program for generating three-dimensional object data, the program causing a computer to function as the components of the three-dimensional object data generation apparatus according to claim 1.
